(19) United States
(12) Patent Application Publication
(10) Pub. No.: US 2015/0219957 A1
(43) Pub. Date: Aug. 6, 2015

(54) LIQUID CRYSTAL DISPLAY DEVICE

(71) Applicant: SHARP KABUSHIKI KAISHA, Osaka-shi, Osaka (JP)

(72) Inventor: Tsuyoshi Kamada, Osaka-shi (JP)

(73) Assignee: SHARP KABUSHIKI KAISHA, Osaka-shi, Osaka (JP)

(21) Appl. No.: 14/428,685

(22) PCT Filed: Sep. 12, 2013
(86) PCT No.: PCT/JP2013/074637

§ 371 Date: Mar. 17, 2015

(30) Foreign Application Priority Data
Sep. 21, 2012 (JP) 2012-208666

(51) Int. Cl. G02F 1/1335

(52) U.S. Cl. CPC G02F 1/133512; G02F 1/133504; G02F 1/1336

(57) ABSTRACT

Provided is a liquid crystal display device in which the scattering of a light control film becomes uniform on a pixel by pixel basis. A liquid crystal display device 1 includes: a light source 2; a liquid crystal panel 4 that modulates light emitted from the light source 2; and a light control film 7 that uses a total reflection and is disposed closer to a viewer side than to the liquid crystal panel 4. The light control film 7 includes a base substrate 39 having light transmission property, and a light-shielding layer 40 and a light diffusing portion 41 formed on one surface side of the base substrate 39. Patterns of the light-shielding layer 40 are anisotropic. A longitudinal direction of the patterns and a longitudinal direction of one region in which a property of the liquid crystal panel 4 is approximately equal intersect each other.

### TECHNICAL FIELD

The present invention relates to a liquid crystal display device.

### BACKGROUND ART

In the related art, in a display system in which a light control film is used for the purpose of wide viewing angle, it is possible to visually recognize an image having a small color change from an oblique direction by light emitted from a backlight being diffused in a light control film after passing through a liquid crystal cell and a polarizer (for example, refer to PTL 1).

### CITATION LIST

### Patent Literature

PTL 1: International Publication No. 2012/053501

### SUMMARY OF INVENTION

### Technical Problem

In the display system described above, when a resolution of the liquid crystal cell is high, the scattering of the light control film becomes non-uniform on a pixel by pixel basis, and thus, there has occurred a problem of roughness in displaying or moire in front of the display, particularly in the oblique direction of the display.

The present invention is made in view of above circumstances and provides a liquid crystal display device in which the scattering of the light control film becomes uniform on a pixel by pixel basis.

### Solution to Problem

A liquid crystal display device according to the present invention includes: a light source; a liquid crystal panel that modulates light emitted from the light source; and a light control film that uses a total reflection and is disposed closer to a viewer side than to the liquid crystal panel side. The light control film includes a base substrate having light transmission property, and a light-shielding layer and a light diffusing portion formed on one surface side of the base substrate. Patterns of the light-shielding layer are anisotropic. A longitudinal direction of the patterns and a longitudinal direction of one region in which a property of the liquid crystal panel is approximately equal intersect each other.

In the liquid crystal display device according to the present invention, it is preferable that the longitudinal direction of the patterns be orthogonal to the longitudinal direction of the one region in which the property of the liquid crystal panel is approximately equal.

In the liquid crystal display device according to the present invention, it is preferable that an interval between the patterns be shorter than the length of the region.

In the liquid crystal display device according to the present invention, it is preferable that two facing sides of the patterns be included in the region.

In the liquid crystal display device according to the present invention, it is preferable that the region be a region having the same transmission spectra.

In the liquid crystal display device according to the present invention, it is preferable that the region be a region in which wavelength bands of transmitted light are substantially the same.

In the liquid crystal display device according to the present invention, it is preferable that the region be a region in which alignment directions of a liquid crystal are regulated substantially in one direction.

In the liquid crystal display device according to the present invention, it is preferable that the region be a region in which alignment directions of a liquid crystal are regulated substantially in one direction, and which is driven by a common voltage.

### Advantageous Effects of Invention

According to the present invention, it is possible to provide a liquid crystal display device in which a difference of diffusion characteristics of each region where a property of the liquid crystal panel is approximately equal decreases, and thus, a uniform display can be obtained.

### BRIEF DESCRIPTION OF DRAWINGS

FIG. 1 is a vertical cross-sectional diagram illustrating an embodiment of a liquid crystal display device according to the present invention.

FIG. 2 is a vertical cross-sectional diagram of a liquid crystal panel.

FIG. 3 is a vertical cross-sectional view of a light control film.

FIG. 4 is a lateral cross-sectional diagram of the light control film.

FIG. 5 is a schematic diagram illustrating an arrangement of a black layer in the light control film.

FIG. 6 is a schematic diagram illustrating an arrangement of the black layer in the light control film.

FIG. 7 is a schematic diagram illustrating an interval between the black layers in the light control film.

FIG. 8 is a schematic diagram illustrating an alignment state of a liquid crystal in a liquid crystal layer.

FIG. 9 is a schematic diagram illustrating a pixel in a liquid crystal panel.

FIG. 10 is a schematic diagram illustrating sub-pixels in the liquid crystal display device.

### DESCRIPTION OF EMBODIMENTS

An embodiment of a liquid crystal display device in the present invention will be described.

The present embodiment is specifically described for better understanding of the spirit of the invention, and does not limit the invention unless otherwise particularly specified.

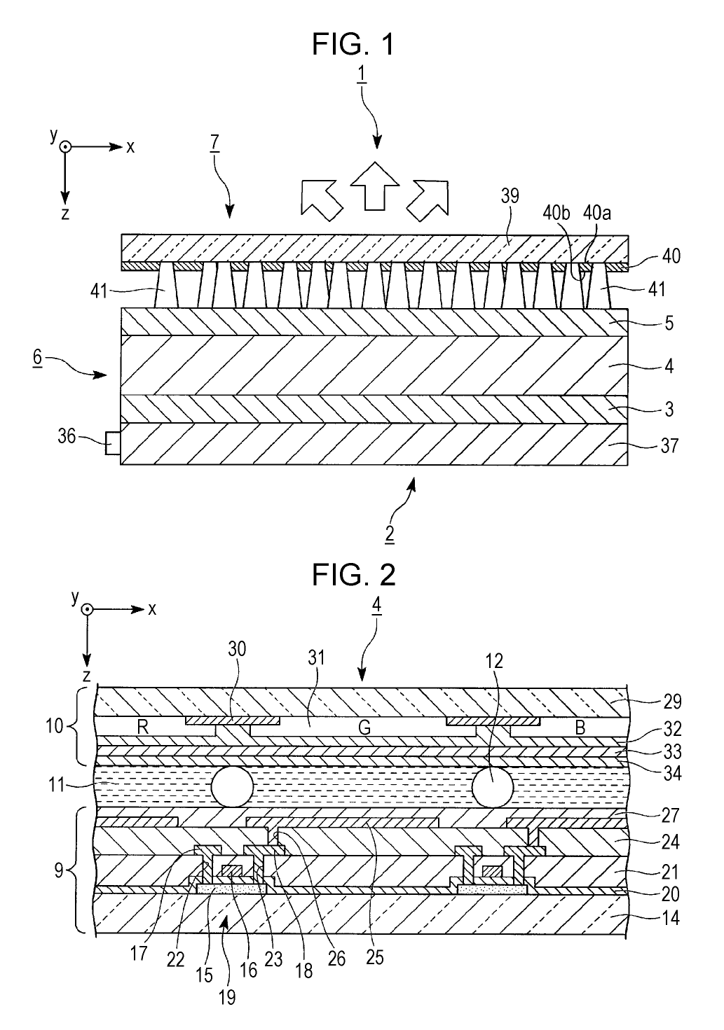

Hereinafter, the embodiment of the present invention will be described referring to FIG. 1 to FIG. 11.

In all of the following drawings, in order to make it easy to see each element, some of the elements may be illustrated by varying the scale of the dimensions.

FIG. 1 is a vertical cross-sectional diagram illustrating an embodiment of a liquid crystal display device.

The liquid crystal display device 1 according to the present embodiment is schematically configured to include a liquid crystal display body 6 that includes a backlight 2 (light source), a first polarizer 3, a liquid crystal panel 4, and a second polarizer 5, and a light control film 7 (viewing angle expansion member or a light diffusing member). In FIG. 1, the liquid crystal panel 4 is schematically illustrated in a plate shape, but the detailed structure thereof will be described below. An observer will see the display from the upper side of the liquid crystal display device 1 on which the light control film 7 is disposed in FIG. 1. Accordingly, in the description below, the side on which the light control film 7 is disposed is referred to as a viewing side and a side on which the backlight 2 is disposed is referred to as a back surface side.

In the liquid crystal display device 1, light emitted from the backlight 2 is modulated by the liquid crystal panel 4, and certain images or characters are displayed by the modulated light. In addition, when the light emitted from the liquid crystal panel 4 passes through the light control film 7, the light is emitted from the light control film 7 with an angular distribution of the emitted light being wider than that before the light is incident on the light control film 7. In this way, the observer can view the display with a wide viewing angle.

Hereinafter, a specific configuration of the liquid crystal panel 4 will be described.

Here, as the liquid crystal panel 4, an active matrix type transmissive liquid crystal panel is exemplified. However, the liquid crystal panel applicable to the present invention is not limited to the active matrix type transmissive liquid crystal panel. For example, the liquid crystal panel applicable to the present invention may be a semi-transmissive (combined type of transmissive and reflection type) liquid crystal panel, or may be a reflection type liquid crystal panel. In addition, the liquid crystal panel applicable to the present invention may be a simple matrix type liquid crystal panel in which each pixel does not include a switching thin film transistor (hereinafter, abbreviated as “TFT”).

FIG. 2 is a vertical cross-sectional diagram of the liquid crystal panel 4.

The liquid crystal panel 4, as illustrated in FIG. 2, includes a TFT substrate 9 as a switching element substrate, a color filter substrate 10 disposed opposing the TFT substrate 9, and a liquid crystal layer 11 interposed between the TFT substrate 9 and the color filter substrate 10. The liquid crystal layer 11 is sealed in a space surrounded by the TFT substrate 9, the color filter substrate 10, and a frame-shaped sealing member (not illustrated) that bonds the TFT substrate 9 and the color filter substrate 10 with a predetermined distance therebetween. The liquid crystal panel 4 performs, for example, the display in a vertical alignment (VA) mode, and a vertically aligned liquid crystal having a negative dielectric anisotropy is used for the liquid crystal layer 11. Between the TFT substrate 9 and the color filter substrate 10, a spherical spacer 12 to maintain the distance between the substrates is disposed. The display mode is not limited to the VA mode, but a twisted nematic (TN) mode, a super twisted nematic (STN) mode, an in-plane switching (IPS) mode, or the like can be used.

In the TFT substrate 9, a plurality of pixels (not illustrated), each of which is a minimum unit of the display, are disposed in a matrix shape. In the TFT substrate 9, a plurality of source bus lines (not illustrated) are formed so as to extend in parallel with each other, and a plurality of gate bus lines (not illustrated) are formed so as to extend in parallel with each other and so as to be orthogonal to the plurality of source bus lines. Therefore, on the TFT substrate 9, the plurality of source bus lines and the plurality of gate bus lines are formed in a lattice pattern, and a rectangular region partitioned by the adjacent source bus lines and the adjacent gate bus lines becomes a pixel. The source bus line is connected to a source electrode of a TFT described below and the gate bus line is connected to a gate electrode of the TFT.

A TFT 19 having a semiconductor layer 15, a gate electrode 16, a source electrode 17, and a drain electrode 18 is formed on a surface of a transparent substrate 14, which configures the TFT substrate 9, at a liquid crystal layer 11 side. A glass substrate, for example, can be used as the transparent substrate 14. The semiconductor layer 15 that is made from semiconductor materials such as continuous grain silicon (CGS), low temperature poly-silicon (LPS), or amorphous silicon (α-Si) is formed on the transparent substrate 14. In addition, a gate insulation film 20 is formed on the transparent substrate 14 so as to cover the semiconductor layer 15. As a material for the gate insulation film 20, for example, a silicon oxide film, a silicon nitride film, a multilayered film thereof, or the like is used.

The gate electrode 16 is formed on the gate insulation film 20 so as to oppose the semiconductor layer 15. As a material for the gate electrode 16, for example, a multilayered film of tungsten (W)/tantalum nitride (TaN), molybdenum (Mo), titanium (Ti), aluminum (Al), or the like is used.

A first insulating interlayer 21 is formed on the gate insulation film 20 so as to cover the gate electrode 16.

As the material for the first insulating interlayer 21, for example, a silicon oxide film, a silicon nitride film, or a multilayered film thereof is used.

The source electrode 17 and the drain electrode 18 are formed on the first insulating interlayer 21.

The source electrode 17 is connected to a source region of the semiconductor layer 15 via a contact hole 22 that penetrates the first insulating interlayer 21 and the gate insulation film 20. Similarly, the drain electrode 18 is connected to a drain region of the semiconductor layer 15 via a contact hole 23 that penetrates the first insulating interlayer 21 and the gate insulation film 20.

As a material for the source electrode 17 and the drain electrode 18, the conductive material similar to that in the gate electrode 16 described above is used.

A second insulating interlayer 24 is formed on the first insulating interlayer 21 so as to cover the source electrode 17 and the drain electrode 18.

As a material for the second insulating interlayer 24, a material similar to that in the first insulating interlayer 21 described above or an organic insulating material is used.

A pixel electrode 25 is formed on the second insulating interlayer 24. The pixel electrode 25 is connected to the drain electrode 18 via a contact hole 26 that penetrates the second insulating interlayer 24. Accordingly, the pixel electrode 25 is connected to the drain region of the semiconductor layer 15 with the drain electrode 18 as a relaying electrode.

As a material for the pixel electrode 25, for example, a transparent conductive material such as indium tin oxide (ITO) or indium zinc oxide (IZO) is used.

With this configuration, a scanning signal is supplied through the gate bus line, and when the TFT 19 is in ON state, an image signal supplied to the source electrode 17 through the source bus line is supplied to the pixel electrode 25 via the semiconductor layer 15 and the drain electrode 18. In addition, an alignment film 27 is formed on the entire surface of the second insulating interlayer 24 so as to cover the pixel electrode 25. This alignment film 27 has an alignment regulating force for vertically aligning liquid crystal molecules that configure the liquid crystal layer 11. The form of the TFT may be a top gate type TFT illustrated in FIG. 2 or may be a bottom gate type TFT.

On the other hand, on the surface of the transparent substrate 29 forming the color filter substrate 10 at the liquid crystal layer 11 side, a black matrix 30, a color filter 31, a planarizing layer 32, an opposing electrode 33, and an alignment film 34 are formed in this order.

The black matrix 30 has a function of blocking the transmission of light in the region between the pixels, and is formed of metal such as chromium (Cr) or a multilayer film of chromium/chromium oxide, or a photo-resist obtained by dispersing carbon particles in the photo-sensitive resin.

Coloring matter of red (R), green (G), or blue (B) is included in the color filter 31, and any one of the color filters 31 of R, G, or B is opposed and disposed on one of the pixel electrodes 25 on the TFT substrate 9.

The planarizing layer 32 is configured from an insulation film covering the black matrix 30 and the color filter 31, and has a function of smoothing and planarizing a step caused by the black matrix 30 and the color filter 31.

The opposing electrode 33 is formed on the planarizing layer 32. As a material for the opposing electrode 33, the transparent conductive material similar to that of the pixel electrode 25 is used.

In addition, an alignment film 34 having a vertical alignment regulating force is formed on the entire surface of the opposing electrode 33.

The color filter 31 may have a multi-color configuration of more than three colors of R, G, and B.

As illustrated in FIG. 1, the backlight 2 includes a light source 36 such as a light emitting diode or a cold-cathode tube and a light guide 37 that causes the light emitted from the light source 36 to be emitted toward the liquid crystal panel 4 using an internal reflection. The backlight 2 may be an edge-light type in which the light source is disposed on the end surface of the light guide body or may be a down-light type in which the light source is disposed immediately below the liquid crystal panel 4. In the backlight 2 in the present embodiment, it is desirable that the backlight having directivity by controlling the direction of the light emission, so-called a directional backlight, is used. By using the directional backlight in which the collimated or substantially collimated light is incident on a light diffusing portion of the light control film 7 described below, it is possible to reduce a blur and improve the efficiency of the light utilization. The above-described directional backlight can be realized by optimizing the shape or arrangement of the reflection pattern which is formed in the light guide 37. In addition, the first polarizer 3 that functions as a polarizer is provided between the backlight 2 and the liquid crystal panel 4. In addition, the second polarizer 5 that functions as an analyzer is provided between the liquid crystal panel 4 and the light control film 7.

Hereinafter, the light control film 7 will be described in detail.

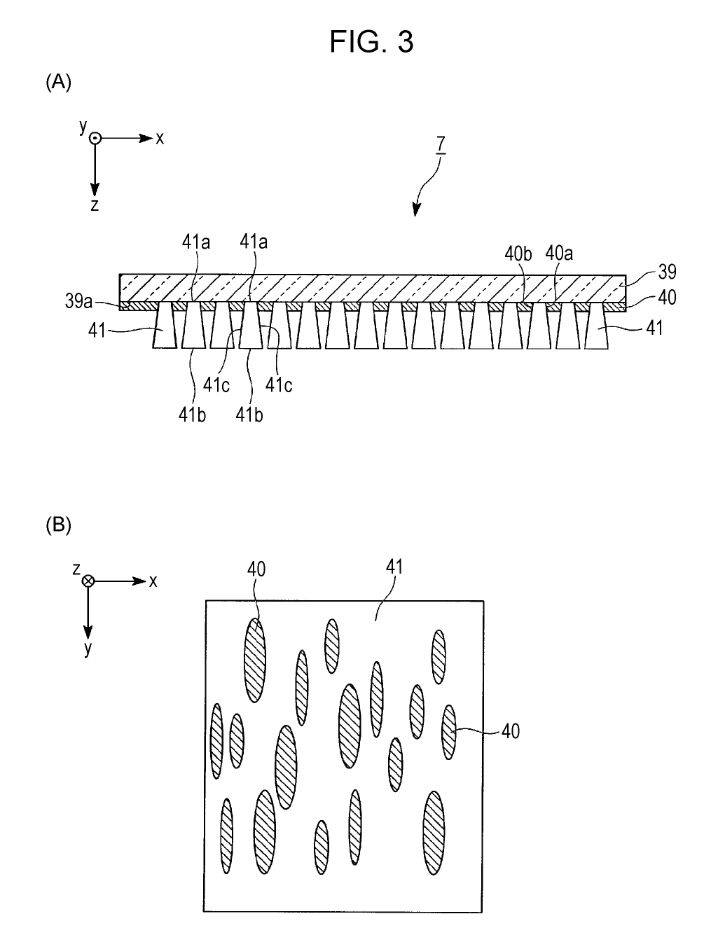

FIG. 3 is a vertical cross-sectional view of the light control film 7.

As illustrated in FIG. 3, the light control film 7 is configured from a base substrate 39, a plurality of black layers (light-shielding layers) 40 formed on one surface (a surface of the side opposite to the viewing side) 39a of the base substrate 39, and a light diffusing portion 41 formed on the one surface 39a of the base substrate 39 that is the same side on which the black layer 40 is formed.

As illustrated in FIG. 1, this light control film 7 is disposed on the second polarizer 5 in a position such that the side on which the light diffusing portion 41 is provided faces the second polarizer 5 and the base substrate 39 side faces the viewing side.

For example, a base material made of transparent resin such as tri-acetyl cellulose (TAC) film, polyethylene terephthalate (PET), polycarbonate (PC), polyethylene naphthalate (PEN), or polyethersulfone (PES) film is preferably used for the base substrate 39.

The base substrate 39 is a base for applying the materials of the black layer 41 and the light diffusing portion 40 later in a manufacturing process described below, and it is necessary to have a heat resistance and mechanical strength in the heat treatment process in the manufacturing process. Therefore, a glass-based substrate may be used as the base substrate 39 other than the resin-based substrate. Here, it is preferable that a thickness of the base substrate 39 be as thin as possible within the range in which there is no loss in heat resistance or the mechanical strength. The reason is that, as the thickness of the base substrate 39 increases, there is a possibility that the blur of the display occurs.

In addition, it is preferable that a total light transmittance of the base substrate 39 be equal to or higher than 90% according to JIS K7361-1. When the total light transmittance is equal to or higher than 90%, a sufficient transparency can be obtained. In the present embodiment, for example, a transparent resin-based substrate which is 100 μm in thickness is used.

The black layer 40 has, for example, an elliptical shape when seen from the viewing side, and as illustrated in FIG. 3(A), the black layers 40 are disposed at random on one surface 39a of the base substrate 39 when seen from the viewing side. It is defined that an x-axis is a horizontal direction of a screen of the liquid crystal panel 4, a y-axis is a vertical direction of the screen of the liquid crystal panel 4, and a z-axis is a thickness direction of the liquid crystal display device 1.

The black layer 40 is configured from an organic material having a light absorption property and photosensitivity such as a black resist. Other than that, a metal film such as chromium (Cr) or a multilayer film of chromium/chromium oxide may be used. The thickness of the black layer 40 is set to be smaller than a height of the light diffusing portion 41 from a light incident end surface 41b to a light emission end surface 41a. In addition, in the space between a plurality of light diffusing portions 41, the black layer 40 exists on a portion which is in contact with one surface 39a of the base substrate 39, and in the portions other than that, air exists.

The light diffusing portion 41 is formed, on one surface 39a of the base substrate 39, on a region other than the region where the black layer 40 is formed.

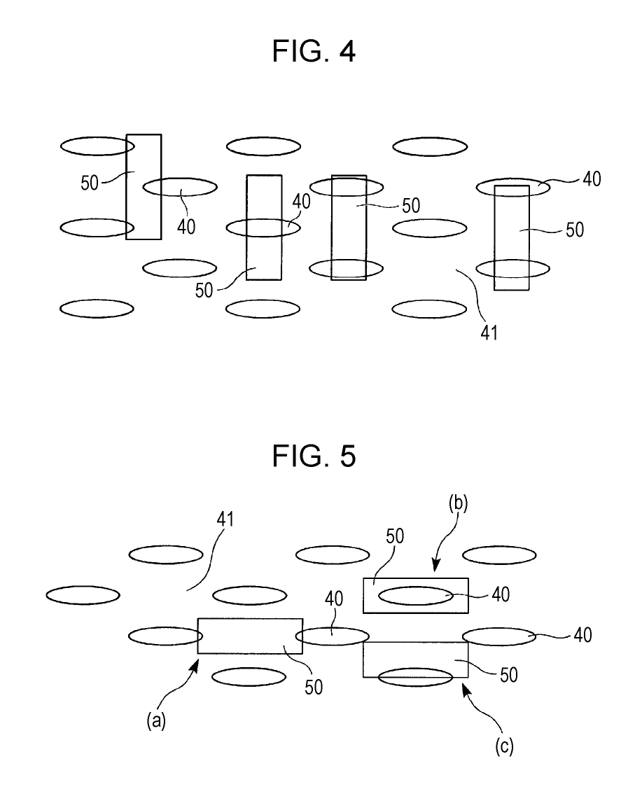

The light diffusing portion 41 is configured from an organic material having a light transparency and photosensitivity such as acrylic resin or epoxy resin. In addition, it is preferable that the total light transmittance of the light diffusing portion 41 be equal to higher than 90% in JIS K7361-1. When the total light transmittance is equal to or higher than 90%, a sufficient transparency can be obtained. As illustrated in FIG. 4(A), the light diffusing portion 41 has the light emission end surface 41a the area of which is small and the light incident end surface 41b the area of which is large, and the area of the horizontal section of the light diffusing portion 41 becomes gradually large from the base substrate 39 side toward the opposite side of the base substrate 39. That is, the light diffusing portion 41 has a so-called reverse tapered shape when seen from the base substrate 39 side. On the other hand, the black layer 40 has a tapered shape when seen from the base substrate 39.

The light diffusing portion 41 is a portion that contributes to the transmission of the light in the light control film 7. That is, the light incident on the light diffusing portion 41 is totally reflected at the tapered side surface 41c of the light diffusing portion 41, and is guided in a state of being confined inside the light diffusing portion 41, and then, is emitted. On the one surface 39a of the base substrate 39, since the light diffusing portion 41 is formed on a region other than the region where the black layer 40 is formed, the light diffusing portion 41 is disposed, as illustrated in FIG. 3(B), at random when seen from the viewing side.

It is preferable that the refractive index of the base substrate 39 and the refractive index of the light diffusing portion 41 be substantially the same. The reason is that, if the refractive index of the base substrate 39 and the refractive index of the light diffusing portion 41 are significantly different, when the light incident from the light incident end surface 41b is to be emitted from the light diffusing portion 41, an unnecessary reflection or refraction occurs at the interface between the light diffusing portion 41 and the base substrate 39, and thus, there is a possibility of problems in that a desired viewing angle is not be obtained or the light intensity of the emitted light decreases.

As illustrated in FIG. 1, since the light control film 7 is disposed such that the base substrate 39 faces the viewing side, out of the two opposing surfaces of the truncated cone-shaped light diffusing portion 41, the surface of small area is the light emission end surface 41a and the surface of large area is the light incident end surface 41b. In addition, the inclination angle (angle between the light emission end surface 41a and a side surface 41c) of the side surface 41c of the light diffusing portion 41 is, for example, approximately 80°. However, the inclination angle of the side surface 41c of the light diffusing portion 41 is not particularly limited, as long as, in such an angle, the incident light is sufficiently diffused when the light is emitted from the light control film 7.

In a case of the present embodiment, since the air is interposed between the adjacent light diffusing portions 41, if the light diffusing portion 41 is assumed to be formed of, for example, transparent acrylic resin, the side surface 41c of the light diffusing portion 41 is the interface between the transparent acrylic resin and the air. Here, even though the surroundings of the light diffusing portion 41 are filled with another material having a low refractive index, the difference of the refractive indices at the interface between the inside and outside of the light diffusing portion 41 is larger in a case where the air exists at the outside than in other cases where any low-refractive materials exist. Therefore, according to Snell's law, the critical angle in the configuration in the present embodiment becomes the smallest, and thus, the range of the incident angle in which the light is totally reflected at the side surface 41c of the light diffusing portion 41 becomes the largest. As a result, it is possible to suppress the loss of the light and to obtain a high intensity of the light.

In addition, in the light control film 7, as illustrated in FIG. 4, the black layer (light-shielding layer) 40 has an elliptical shape when seen from the viewing side, and a longitudinal direction of the black layer (light-shielding layer) 40 and a longitudinal direction of one region 50, in which a property of the liquid crystal panel is approximately equal, in the liquid crystal panel 4 intersect each other.

The region 50 in which a property of the liquid crystal panel is approximately equal will be described below.

Since the light diffusing layer 41 on the black layer 40 has a tapered shape when seen from the base substrate 39 side, the light diffusing directions on the upper surface 40a and the lower surface 40b of the black layer 40 are different from each other. By the black layer 40 being uniformly combined with the region 50, the display of the liquid crystal display device 1 becomes uniform.

In FIG. 4, even though there are some variations, since a part of the upper surface and the lower surface of the black layer 40 is disposed in the region 50, the difference of the diffusion characteristics for each region 50 decreases, and it is easy to obtain the uniform display.

In addition, in the point that the diffusion characteristics can easily be uniform, it is preferable that the longitudinal direction of the black layer 40 be vertical with respect to the longitudinal direction of the region 50 (the longitudinal direction of the black layer 40 be orthogonal to the longitudinal direction of the region 50).

Here, as illustrated in FIG. 5, a case where the longitudinal direction of the black layer 40 does not cross the longitudinal direction of the region 50 but the longitudinal direction of the black layer 40 is parallel with the longitudinal direction of the region 50 will be described.

In a portion (a) in FIG. 5, since the black layer 40 almost does not exist in the region 50, the light is not diffused. In a portion (b), most of the region 50 is covered by the black layer 40 and the light is strongly diffused, and thus the transmittance becomes low. In a portion (c), only the upper surface of the black layer 40 is superimposed over the region 50, and it has asymmetrical characteristics in which there is a light distribution to the upper surface direction of the black layer 40 but there is no light distribution to the lower surface direction of the black layer 40. As described above, when the longitudinal direction of the black layer 40 is parallel with the longitudinal direction of the region 50, the difference of the diffusion characteristics for each region 50 increases, and thus, it is not possible to obtain the uniform display.

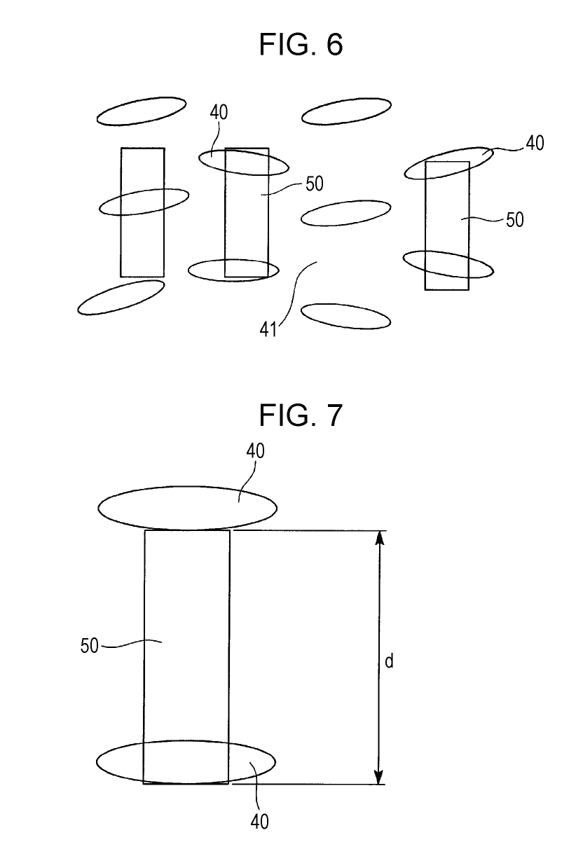

In addition, as illustrated in FIG. 4, the disposing of the black layer 40 with respect to the region 50 is not limited to the case where the longitudinal direction of the black layer 40 is orthogonal to the longitudinal direction of the region 50, but it is possible to obtain the effect of uniformizing the diffusion characteristics as long as the longitudinal direction of the black layer 40 and the longitudinal direction of the region 50 intersect each other. For example, as illustrated in FIG. 6, for the purpose of uniformizing the moire or the characteristics caused by the interference with the region 50, the orientation or the position of the black layer 40 may be random.

In addition, it is preferable that two facing sides of the elliptical shape of the black layer 40 be included in the region 50.

In this way, at least a part of the upper surface and the lower surface of the black layer 40 is disposed in the region 50. Therefore, the difference of the diffusion characteristics for each region 50 decreases and thus, it is possible to easily obtain a uniform display.

Furthermore, as illustrated in FIG. 7, it is preferable that an interval (pitch) d between the black layers 40 be shorter than the length of the region 50 in the longitudinal direction. In this way, at least a part of the upper surface and the lower surface of the black layer 40 is disposed in the region 50. Therefore, the difference of the diffusion characteristics for each region 50 decreases, and thus, it is possible to easily obtain a uniform display.

In the present embodiment, the case where the shape of the black layer 40 seen from the viewing side is an elliptical shape is described. However, the present embodiment is not limited to this case, and the shape of the black layer 40 seen from the viewing side may be any other shape as long as the shape has anisotropy. As examples of the black layer 40 having such a shape, a rectangular shape, a diamond shape, and the like are included.

One region 50 in which a property of the liquid crystal panel is approximately equal will be described.

As the region 50, there are: a region having the same transmission spectra, a region in which the wavelength bands of the transmitted light are substantially the same, a region in which the alignment directions of the liquid crystal are regulated in one direction, a region in which the alignment directions of the liquid crystal are regulated in one direction, and which is driven by a common voltage, and the like.

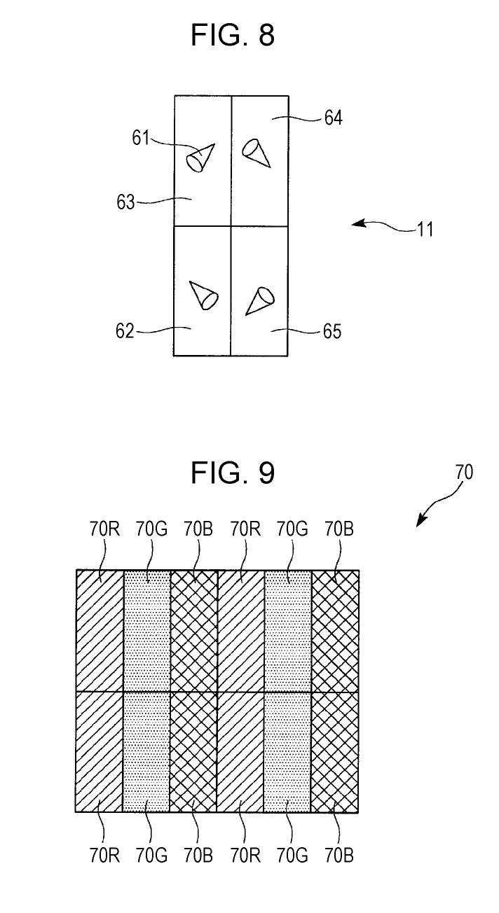

FIG. 8 is a schematic diagram illustrating an alignment state of a liquid crystal in a liquid crystal layer 11. In the diagram, a part illustrated in a conical shape is a liquid crystal 61.

In domains 62 to 65 of the liquid crystal cell that configures the liquid crystal layer 11, pre-tilt directions of the liquid crystal 61 at the center portion of the liquid crystal layer 11 in the layer thickness direction are different from each other. In the domains 62 to 65, the change of the alignment state of the liquid crystal 61 occurs in a plane that includes an axis that makes 45° with the x-axis, and the z-axis. In the domain 62 and the domain 64, the tilt directions of the liquid crystal 61 are opposite to each other across the line parallel with the Z axis through the center of the pixel electrode. In the domain 63 and the domain 65, the tilt directions of the liquid crystal 61 are opposite to each other across the line parallel with the Z axis through the center of the pixel electrode.

One domain (a single domain) among the domains 62 to 65 having the above-described relationships is to be a region having the same transmission spectra which is one of the regions 50 in the present embodiment.

That is, in the present embodiment, the black layer 40 and one of the domains 62 to 65 are disposed such that the longitudinal directions thereof intersect each other.

FIG. 9 is a schematic diagram illustrating a pixel in a liquid crystal panel 4.

The pixel 70 is configured to include a red segment 70R, a green segment 70G, and a blue segment 70B.

In the present embodiment, the red segment 70R, the green segment 70G, and the blue segment 70B are to be the region in which the wavelength range of the transmitted light is substantially the same, and which is one region 50.

That is, in the present embodiment, the black layer 40 and one of the red segment 70R, the green segment 70G, and the blue segment 70B are disposed such that the longitudinal directions thereof intersect each other.

In the present embodiment, the case where the pixel 70 is configured to include the red segment 70R, the green segment 70G, and the blue segment 70B is described. However, the present embodiment is not limited thereto, and the pixel may be configured to include the red segment, the green segment, the blue segment, and a yellow segment, or the pixel may be configured to include the red segment, the green segment, the blue segment, the yellow segment, and a cyan segment.

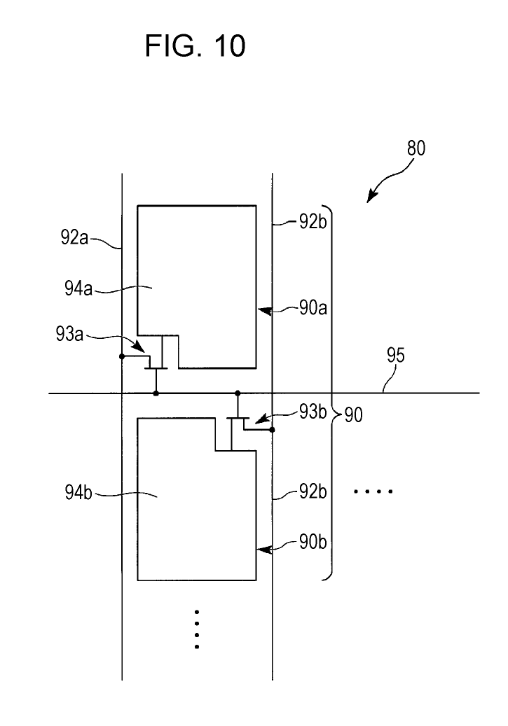

FIG. 10 is a schematic diagram illustrating sub-pixels of the liquid crystal display device.

A liquid crystal display device 80 includes two sub-pixel electrodes 94a and 94b that are connected to mutually different signal lines 92a and 92b via corresponding TFTs 93a and 93b.

Gates of the TFTs 93a and 93b that configure sub-pixels 90a and 90b are connected to the common scanning lines (gate bus lines) 95, and controlled to be ON or OFF by the same scanning signal. Since the signal lines (source bus lines) 92a and 92b are different from each other, the sub-pixels 90a and 90b are able to be controlled to have the completely different voltage.

In the present embodiment, the sub-pixels respectively corresponding to the sub-pixel electrodes 94a and 94b are to be one of the regions 50 in which the alignment direction of the liquid crystal is regulated substantially in one direction, and which is driven by the common voltage.

That is, in the present embodiment, the black layer 40 and the sub-pixels respectively corresponding to the sub-pixel electrodes 94a and 94b are disposed such that the longitudinal directions thereof intersect each other.

In the present embodiment, the case where the liquid crystal display device includes two sub-pixels is described. However, the present embodiment is not limited thereto, and the liquid crystal display device may include three or more sub-pixels.

In addition, in the present embodiment, in a case where the sub-pixels are divided into the domains in which the alignment states of the liquid crystal are different as illustrated in FIG. 8, the number of domains is the number of sub-pixels×the number of domains for each sub-pixel, and each of those individual domains may be the region 50.

### INDUSTRIAL APPLICABILITY

The present invention can widely be used in the technical field of the liquid crystal display device.

### REFERENCE SIGNS LIST

1 LIQUID CRYSTAL DISPLAY DEVICE
2 BACKLIGHT (LIGHT SOURCE)
3 FIRST POLARIZER
4 LIQUID CRYSTAL PANEL
5 SECOND POLARIZER
6 LIQUID CRYSTAL DISPLAY BODY
7 LIGHT CONTROL FILM
9 TFT SUBSTRATE
10 COLOR FILTER SUBSTRATE
11 LIQUID CRYSTAL LAYER
12 SPACER
14 TRANSPARENT SUBSTRATE
15 SEMICONDUCTOR LAYER
16 GATE ELECTRODE
17 SOURCE ELECTRODE
18 DRAIN ELECTRODE
19 TFT
20 GATE INSULATION FILM
21 FIRST INSULATING INTERLAYER
22, 23, 26 CONTACT HOLE
24 SECOND INSULATING INTERLAYER
25 PIXEL ELECTRODE
27 ALIGNMENT FILM
29 TRANSPARENT SUBSTRATE
30 BLACK MATRIX
31 COLOR FILTER
32 PLANARIZING LAYER
33 OPPOSING ELECTRODE
34 ALIGNMENT FILM
36 LIGHT SOURCE
37 LIGHT GUIDE
39 SUBSTRATE
40 BLACK LAYER (LIGHT-SHIELDING LAYER)
41 LIGHT DIFFUSING PORTION
50 REGION
61 LIQUID CRYSTAL
62, 63, 64, 65 DOMAIN
70 PIXEL
80 LIQUID CRYSTAL DISPLAY DEVICE
92a, 92b SIGNAL LINE
93a, 93b TFT
94a, 94b SUB-PIXEL ELECTRODE
95 SCANNING LINE

1. A liquid crystal display device comprising:
a light source;
a liquid crystal panel that modulates light emitted from the light source; and
a light control film that uses a total reflection and is disposed closer to a viewer side than to the liquid crystal panel side, wherein
the light control film includes a base substrate having light transmission property, and a light-shielding layer and a light diffusing portion formed on one surface side of the base substrate,
patterns of the light-shielding layer are anisotropic, and
a longitudinal direction of the patterns and a longitudinal direction of one region in which a property of the liquid crystal panel is approximately equal intersect each other.

2. The liquid crystal display device according to claim 1,
wherein the longitudinal direction of the patterns is orthogonal to the longitudinal direction of the one region in which the property of the liquid crystal panel is approximately equal.

3. The liquid crystal display device according to claim 1,
wherein an interval between the patterns is shorter than a length of the region.

4. The liquid crystal display device according to claim 1,
wherein two facing sides of the patterns are included in the region.

5. The liquid crystal display device according to claim 1,
wherein the region is a region having the same transmission spectra.

6. The liquid crystal display device according to claim 1,
wherein the region is a region in which wavelength bands of transmitted light are substantially the same.

7. The liquid crystal display device according to claim 1,
wherein the region is a region in which alignment directions of a liquid crystal are regulated substantially in one direction.

8. The liquid crystal display device according to claim 1,
wherein the region is a region in which alignment directions of a liquid crystal are regulated substantially in one direction, and which is driven by a common voltage.
